(19) United States
(12) Patent Application Publication
(10) Pub. No.: US 2010/0188868 A1
(43) Pub. Date: Jul. 29, 2010

(54) Three-layer light guiding structure

(76) Inventors: Hsing-Lieh Chuang, Taipei (TW); Cheng-Yen Chuang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/320,390

(22) Filed: Jan. 26, 2009

(51) Int. Cl. G02B 6/00; F21V 8/00

(52) U.S. Cl. 362/619

(57) ABSTRACT

A three-layer light guiding structure includes a light-guiding layer having a light-output face with a plurality of patterned points imprinted thereon; a middle light-transmittable layer being located at a bottom of the light-guiding layer opposite to the light-output face; and a reflecting layer being located at a bottom of the middle light-transmittable layer opposite to the light-guiding layer. The three-layer light guiding structure is formed through the coextrusion molding process, so that the light-guiding layer, the middle light-transmittable layer and the reflecting layer are integrally formed and bonded to one another after the molding.

### FIELD OF THE INVENTION

The present invention relates to a three-layer light guiding structure, and more particularly to a three-layer light guiding structure formed through a coextrusion molding process, so that a light-guiding layer, a middle light-transmittable layer, and a reflecting layer are bonded to one another when the light guiding structure is molded.

### BACKGROUND OF THE INVENTION

In recent years, the liquid crystal display (LCD) has been largely increased in size and is able to provide colorized images, allowing it to be more widely applied to different fields, such as notebook computers, cell phones, LCD televisions, etc. Since the LCD itself is a passive component and does not emit light, it requires a light source system to serve as its light source, such as a backlight module. A backlight module usually consists of a reflector, diffusion films, prism lens, a light guiding plate, and one or more light sources. The light guiding plate is an important component in the backlight module, and is used to guide light to different scattering directions, so that a linear light source or a spot light source can be converted into a surface light source to emit light.

Generally, the light guiding plate is a flat plate made of a resin material with high light transmittance, and has a plurality of differently sized dots distributed thereon in different densities. Usually, the flat plate is formed by injection molding a plastic material, and the dots can be formed when the flat plate is injection molded. Alternatively, the flat plate for the light guiding plate can be formed first, and the dots are formed on the flat plate by printing a non-light-absorbing ink on the flat plate by way of screen-printing.

The reflector is a sheet material made of a resin material having a high reflectivity, and is usually formed by foaming polyethylene terephthalate (PET) or polypropylene (PP), or plating a layer of metal material on the surface of the PET or PP material. The reflector is then attached to the light guiding plate. That is, the light guiding plate and the reflector must be manufactured separately, and therefore, require different molding apparatus and process techniques. In the past, the light guiding plate and the reflector are attached to each other using a bonding agent, which will increase the manufacturing cost and time.

It is therefore desirable to develop a complex structure that combines a light-guiding layer with a middle light-transmittable layer and a reflecting layer without the need of using a bonding agent and has dots being formed on the light-guiding layer when the three-layer light guiding structure is molded.

### SUMMARY OF THE INVENTION

A primary object of the present invention is to provide a three-layer light guiding structure consisting of a light-guiding layer, a middle light-transmittable layer, and a reflecting layer, which are integrally formed and bonded to one another through casting coextrusion molding process. Meanwhile, a plurality of patterned points is also imprinted on a light-output face of the light-guiding layer when the three-layer light guiding structure is molded. Therefore, the three-layer light guiding structure can be produced at largely reduced manufacturing cost, compared to the conventional light guiding plate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic side view of a three-layer light guiding structure according to a preferred embodiment of the present invention;

FIG. 2 is a schematic side view of a light-guiding layer for the three-layer light guiding structure according to another embodiment of the present invention, on which a plurality of pits are formed; and

FIG. 3 is a schematic side view showing the optical paths of light in the three-layer light guiding structure of the present invention.

### DETAILED DESCRIPTION OF THE PREFERRED EMBODIMENTS

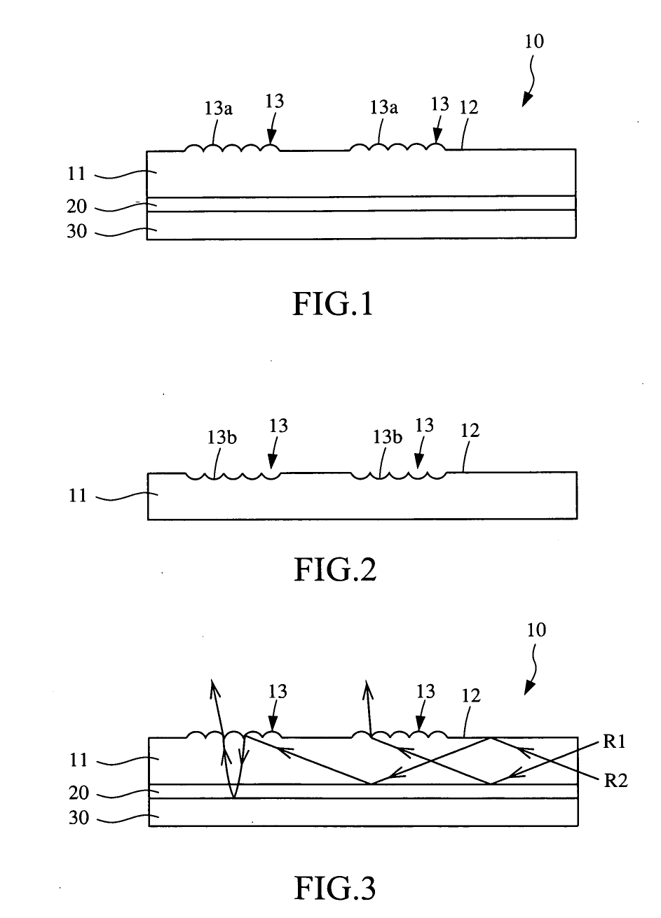

Please refer to FIG. 1. A three-layer light guiding structure 10 according to a preferred embodiment of the present invention includes a light-guiding layer 11, a middle light-transmittable layer 20 located below the light-guiding layer 11, and a reflecting layer 30 located below the middle light-transmittable layer 20.

The light-guiding layer 11 can be made of a thermoplastic resin material, such as polycarbonate (PC), which has a refractive index of 1.58 to show a good optical effect.

The light-guiding layer 11 has a light-output face 12, on which there is provided a plurality of patterned points 13 capable of destroying total internal reflection. In the illustrated preferred embodiment, the patterned points consist of a plurality of dots 13a, as shown in FIG. 1. However, in another embodiment of the present invention, the patterned points 13 consist of a plurality of pits 13b, as shown in FIG. 2. The points 13 can be round, square, rhombic, or any other geometrical shape.

The middle light-transmittable layer 20 can be made of a thermoplastic resin material, such as polymethylmethacrylate (PMMA), which has a refractive index of 1.49. Since the middle light-transmittable layer 20 has a refractive index lower than that of the light-guiding layer 11, light entering the light-guiding layer 11 will propagate therein due to total internal reflection.

The reflecting layer 30 can be made of a thermoplastic resin material, such as polycarbonate (PC). Talc powder or titanium dioxide (TiO₂) powder can be added to the resin material for the reflecting layer 30 to provide good reflection effect. The reflecting layer 30 is attached to a bottom of the middle light-transmittable layer 20 opposite to the light-guiding layer 11. The light-guiding layer 11, the middle light-transmittable layer 20, and the reflecting layer 30 are bonded together by forming them at the same time through the coextrusion molding technique.

In the present invention, it is preferably to form the light-guiding layer 11, the middle light-transmittable layer 20, and the reflecting layer 30 through casting coextrusion molding, so that a three-layer flat plate structure can be obtained. The produced three-layer flat plate structure is then subjected to roll cooling. Meanwhile, desired patterns are imprinted on the light-output face 12 of the light-guiding layer 11 to form the light-guiding patterned points 13.

FIG. 3 schematically shows the optical paths of light in the light-guiding layer 11. When an incident light R1 propagating in the light-guiding layer 11 due to total internal reflection reaches at any one of the patterned points 13, the total internal reflection is destroyed. At this point, the light R1 will directly pass through the light-output face 12 and be refracted out of the light-guiding layer 11. Or, in another situation, when an incident light R2 propagating in the light-guiding layer 11 due to total internal reflection reaches at any one of the patterned points 13, the total internal reflection is destroyed. At this point, the light R2 is reflected downward to pass through the middle light-transmittable layer 20 and reach at the reflecting layer 30, from where the light R2 is reflected to enter the middle light-transmittable layer 20 and the light-guiding layer 11 again and finally passes through the light-output face 12 of the light-guiding layer 11 into an external environment. Therefore, by controlling the position, size, and density of the patterned points 13, the light entering the light-guiding layer 11 can be guided to locations that need backlight to provide uniformly distributed brightness.

In summary, the present invention provides a three-layer light guiding structure, which is produced by coextrusion molding of the light-guiding layer 11, the middle light-transmittable layer 20 and the reflecting layer 30, and forming a plurality of patterned points 13 on the light-guiding layer 11 at the same time. When the three-layer light guiding structure is molded, the light-guiding layer 11 is also bonded to the middle light-transmittable layer 20 and the reflecting layer 30 without the need a glue dispensing procedure. Thus, the three-layer light guiding structure of the present invention can be produced at largely reduced manufacturing cost and time. Moreover, the three-layer light guiding structure of the present invention has high rate of light utilization to enable even emission of the incident light from the light-guiding layer 11.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A three-layer light guiding structure, comprising:
a light-guiding layer having a light-output face, on which a plurality of patterned points is provided;
a middle light-transmittable layer being located below the light-guiding layer opposite to the light-output face; and
a reflecting layer being located below the middle light-transmittable layer opposite to the light-guiding layer; and
wherein the light-guiding layer, the middle light-transmittable layer and the reflecting layer are integrally formed to bond to one another through a coextrusion molding process.

2. The three-layer light guiding structure as claimed in claim 1, wherein the patterned points can be dots or pits.

3. The three-layer light guiding structure as claimed in claim 1, wherein the middle light-transmittable layer has a refractive index lower than that of the light-guiding layer.

4. The three-layer light guiding structure as claimed in claim 1, wherein the reflecting layer is made of a thermoplastic resin material, including polycarbonate (PC), and can have talc powder or titanium dioxide powder added thereto.

5. The three-layer light guiding structure as claimed in claim 3, wherein the light-guiding layer is made of a thermoplastic resin material, including PC, which has a refractive index of 1.58; and the middle light-transmittable layer is made of a thermoplastic resin material, including polymethylmethacrylate (PMMA), which has a refractive index of 1.49.
